(19) United States
(12) Patent Application Publication
(10) Pub. No.: US 2013/0034638 A1
(43) Pub. Date: Feb. 7, 2013

(54) BIODEGRADABLE, BIOCOMPATIBLE AND NON-TOXIC MATERIAL, SHEETS CONSISTING OF SAID MATERIAL AND THE USE THEREOF IN FOOD, PHARMACEUTICAL, COSMETIC AND CLEANING PRODUCTS

(71) Applicants: Silvia Nair Goyanes, Buenos Aires (AR); Mirta Ines Aranguren, Prov. de Buenos Aires (AR); Nancy Lis Garcia, Prov. de Buenos Aires (AR); Lucia Mercedes Fama, Buenos Aires (AR); Laura Ribba, Buenos Aires (AR); Alain Dufresne, Buenos Aires (AR)

(72) Inventors: Silvia Nair Goyanes, Buenos Aires (AR); Mirta Ines Aranguren, Prov. de Buenos Aires (AR); Nancy Lis Garcia, Prov. de Buenos Aires (AR); Lucia Mercedes Fama, Buenos Aires (AR); Laura Ribba, Buenos Aires (AR); Alain Dufresne, Buenos Aires (AR)

(73) Assignees: INIS BIOTECH LLC, Milford, DE (US); CONSEJO NACIONAL DE INVESTIGACIONES CIENTIFICAS Y TECHICAS (CONICET), Buenos Aires (AR)

(21) Appl. No.: 13/520,953

(22) PCT Filed: Jan. 7, 2011
(86) PCT No.: PCT/IB11/50066

§ 371 Date: Oct. 22, 2012

(30) Foreign Application Priority Data
Jan. 8, 2010 (AR) P100100044

(51) Int. Cl. A23L 3/349; C09D 103/02; C08L 3/02; B82Y 30/00

(52) U.S. Cl. 426/323; 106/215.5; 428/220; 106/15.05; 426/321; 977/773

(57) ABSTRACT

A biodegradable, biocompatible and non-toxic material is disclosed, which may be used to isolate and/or to protect a product from the environment, wherein said material comprises a matrix composed by starch, glycerol and starch nano-crystals dispersed in said matrix. The material may be used in the form of foils, sheets, films, coatings, gels, etc, to isolate and/or to protect a product from the environment. The material may be used to isolate and or to protect food, pharmaceutical, cosmetic and cleaning products.

Parts of the present application were disclosed within the terms of articles 5 of the Patent Law (Law 24,481 as amended by Law 24 m572, T.O. 1996—B.O. 22/3/96, As amended by Law 25 m859) and its regulations, in “Physico-Mechanical Properties of Biodegradable Starch Nanocomposites”, Macromol. Mater. Eng. 2009, 294, 169-177; published on line on Jan. 8, 2009, which is included herein as a reference.

The present invention refers to biodegradable, biocompatible and non-toxic material, which may be used to isolate and/or to protect a product from the environment, wherein said material comprises a matrix composed by starch, glycerol and starch nano-crystals dispersed in said matrix. In a preferred embodiment of the invention, the starch matrix is formed by tapioca starch, while the starch nano-crystals dispersed in said matrix are corn starch nano-crystals. The material of the invention may be used to isolate, for example, food, pharmaceutical and/or cosmetic products. Likewise, in a preferred embodiment, it may be used to isolate a cleaning product.

In another particular embodiment, the material of the invention is in the form of sheets and even more particularly, in the form of sealable sheets. Thus, the invention also involves sheets, films and biodegradable, biocompatible and non-toxic films comprising the material of the invention. In particular embodiments, sheets of the invention may be used for the manufacturing of bags. Even more particularly, may be used to package food.

On the other hand, the invention also refers to procedures useful to protect a food from degradation or to keep the smell of food, comprising pulverize or spray the food with a solution comprising the biodegradable, biocompatible and non-toxic material of the invention or comprising immersing the foodstuff in a solution comprising the biodegradable, biocompatible and non-toxic material of the invention.

### BACKGROUND OF THE INVENTION

The replacement of synthetic polymers by biopolimeros in the area of packaging and wrapping is one of the most important items for the last years. Within this context, the starch as a thermoplastic material has been under study for about twenty years, as it refers to raw material which is cost efficient, abundant, renewable and biodegradable. Sin embargo, up to date, little applications have been able to be achieved, mainly, since the thermoplastic starch shows a great sensitivity to water, which is increased by the presence of a plasticizer (which, generally, is a polyalcohol). The hydrophilic nature of plasticized starch makes it very susceptible to the attack of moisture, resulting in changes in dimensional stability and its mechanical properties. Also, the retro gradation and crystallization of mobile chains of starch lead to undesired changes in its thermo-mechanic properties.

On the other hand, in the last years, a type of starch, rich in amylopectin, called “Waxy” has been used to obtain monocrystalline nanoparticles which are rigid and with nanometric size. These nanoparticles, obtained by an acid hydrolysis of the Waxy starch grains, have been used as nano-reinforcement in different “nanocompounds” (see Angellier, H. et al Biomacromolecules 5, 1545-1551, (2004); “Thermoplastic cassava starch-waxy corn starch nanocrystals nanocomposites” in Recent Advances in Research on Biodegradable Polymers and Sustainable Composites (Volume 2). Ed: Alfonso Jimenez, Gennady E. Zaikov. 2008, ISBN: 978-1-60692-094-7 and Garcia, L. Famá et al; “A comparison between the physico-chemical properties of tuber and cereal starches”. Carbohydrate Polymers, sent to publication).

By way of example, its inclusion by means of a physical mixture, in poly(styrene-co-butyl acrilate) (see Dufresne, A. et al; J. Polym. Sci., Part B: Polym. Phys., 36 (12), 2211-2224, (1998)), in natural rubber (see Angellier, H. et al; Macromolecules, 38 (22), 9161-9170, (2005)), in polyurethanes (see Guangjun Chen et al; Polymer 49, 1860-1870, (2008)), pullulan (see Eleana Kristo et al; Carbohydrate Polymers 68, 146-158, (2007)), o in starch matrixes, Waxy (see Angellier H. et al, Biomacromolecules; 7: 531-539, (2006)) o Cassava (see “Thermoplastic cassava starch-waxy corn starch nanocrystals nanocomposites” en Recent Advances in Research on Biodegradable Polymers and Sustainable Composites (Volume 2). Ed: Alfonso Jimenez, Gennady E. Zaikov. 2008, ISBN: 978-1-60692-094-7 and Garcia, L. Famá et al; “A comparison between the physico-chemical properties of tuber and cereal starches”. Carbohydrate Polymers, sent to publication) led to interesting reinforcement properties.

However, the changes produced by the inclusion of starch nanoparticles in the barrier properties were, up to date, scarcely studied. Recently, the inventors of this invention showed that its incorporation in a Cassava starch matrix leads to improvements within the range of 40% in water vapor permeability and in about 380% in the storage module at 50° C. Thus, since strong increases have been observed either in the storage module or in water vapor permeability, these new compounds appear to be excellent from the point of view of their possible application to packaging materials.

### BRIEF DESCRIPTION OF THE INVENTION

The present invention refers to a biodegradable, biocompatible and non-toxic material, which may be used to isolate and/or to protect a product from the environment, wherein said material comprises a matrix composed by starch, glycerol and starch nano-crystals dispersed in said matrix. The material may be used in the form of foils, films, sheets, coatings, gels, etc, to isolate and/or to protect a product from the environment.

### DETAILED DESCRIPTION OF THE INVENTION

It is an object of the present invention, a biodegradable, biocompatible and non-toxic material, which may be used to isolate and/or to protect a product from the environment, wherein said material comprises a matrix composed by starch, glycerol and starch nano-crystals dispersed in said matrix. In a preferred embodiment of the invention, the starch matrix is formed by tapioca starch, while the starch nano-crystals dispersed in said matrix are corn starch nano-crystals. In another preferred embodiment of the invention, the starch matrix is formed by starch waxy, while the starch nano-crystals dispersed in said matrix are corn starch nano-crystals. In particular embodiments, the corn nano-crystals spread in the matrix have an average size of less than about 100 nm y, preferably, have an average size between about 50 nm and about 100 nm. In other particular embodiments, said nanocrystals are in a ratio between about 2.5% and about 5% by weight, regarding the total weight of the material.

The material of the invention is, also, completely thermoplastic, renewable, and flexible and can be easily conditioned to different processes of heat plasticization by the use of equipment commonly used in the manufacturing of synthetic polymers.

The material of the invention may be obtained from the jellification of the starch, using glycerol as plasticizing agent. During the preparation of the matrix, crystalline nanoparticles obtained previously by acid hydrolysis of the waxy corn starch are added. These added crystals with nanometric size confer unique properties of water vapor permeation, mechanic resistance, transparency to material, etc.

A procedure used in the procurement of the material of the invention may be as follows: Nanocrystals are obtained by acid hydrolysis of 36,725 g of the Waxy corn starch in 250 ml of 3.16 M sulphuric acid (H₂SO₄) at 40° C. and constant stirring (100 rpm) for 5 days. Subsequently the crystals are washed and separated in distilled water (by successive distillations) until neutral pH. Afterwards, they are stored at 4° C. with some drops of an antimicrobial agent. On the other hand, mix 15 g of starch and water (2:1 by weight) and the mixture is dispersed in 185 g of distilled water. Then, the mixture is heated to jellification temperature (˜70° C.) and the gel is degassed for 30 min with vacuum with a mechanic pump. At this point, the suspension of nanocrystals is added in the desired amount (2.5 to 5 w/w. % relative to the total mass of starch, plasticizer and nanocrystals). After that, the mixture is stirred again for 10 min. at 250 rpm and the degassing is ended for an additional of one hour. Finally, the mixture is poured into Petri dishes, (in the case of films) and is cured in an oven at 50° C. for 24 hours, thus obtaining films between 150-300 μm of thickness. In the case of the gel, the material may be used directly after degassing.

Nanocrystals, once obtained by acid hydrolysis of the Waxy corn starch, are added to the matrix thus assuring its complete dispersion therein through prior sonication of the aqueous solution of nanocrystals and stirring at about 250 rpm when added to the matrix. This dispersion could be proved by SEM Microscopy, analyzing the surfaces of cryogenic fractures, observing a good dispersion of the nanoparticles in the matrix.

The morphological characteristics of the nanoparticles were studied by scan and transmission electronic microscopy. Nanocrystals showed an approximate size between 50 nm and 100 nm and in aqueous suspension they may form aggregates of between 1-5 μm, showing morphological characteristics very similar to the previously described by Angellier et al (see Biomacromolecules 2004; 5:1545-1551) or the recently introduced by Chen et al (“Edible films and coatings to improve food quality”, 1994, Technomic Publishing Co. Inc., Lancaster, Pa.) obtained from the starch of leguminous plants.

The biodegradable, biocompatible and non-toxic material of the invention has diverse industrial applications. Among them, it may be used to isolate and/or to protect products from the environment. In particular, said products may be selected among food products, pharmaceutical products, cosmetic products and cleaning products.

In accordance to the present application, los términos “food products”, “pharmaceutical products”, “cosmetic products” and “cleaning products”, should be meant in the broadest sense. Thus, the terms “food products” include, but are not limited to, natural food, artificial food, substances that may be ingested, additives used in food and food which have been mainly changed their physical features as a consequence of industrial manipulation. Likewise, the terms “pharmaceutical products” include, but are not limited to, drugs, therapeutically active substances, pharmaceutical formulations, finished pharmaceutical products and pharmaceutically acceptable substances, additives and excipients. The terms “cosmetic products” include, but are not limited to, cosmetic use substances, cosmetic formulations, perfumes and finished cosmetic products. Also, the terms “cleaning products” include, but are not limited to soaps, detergents, air fresheners, cleaners, disinfectants and bleaches.

The material of the invention may be used, either in the form of gel or forming thin foils, to coat products. Thus, it may successfully substitute the typical stretchable PVC films used to protect, among others, fruits or products found in trays of the so called “fast food”.

The main features sought in a particular application will depend on the food to be covered and the primary deterioration way. The functional properties of the foils are strongly influenced by such parameters as its composition, manufacturing process, and/or drying, and will be sought for a particular application depending on the food to be covered and its deterioration way. In general, from an industrial point of view, the addition of antimicrobial agents is necessary to prevent the deterioration of food. Various compounds have been approved by international regulatory agencies to be used as direct food antimicrobial agents however many of them produce adverse reactions to sensitive persons. A film with nanocrystals in agreement with the invention will prevent the decomposition of certain feed without the need of imperatively adding antimicrobial agents. It is worthy to note, however, that the results support that the films of the invention may be also prepared by adding antimicrobial agents such as potassium sorbate without affecting the properties of the film or gel.

In a preferred embodiment of the invention, the product to be isolated or protected is in the form of powder, granulate or small pieces. In another embodiment, the product to be isolated or protected is in the form of big pieces. The products may be protected or isolated by directly using the material of the invention over the product, over products on trays, containers or supports, or on final products that are already packaged in their primary packages.

In a preferred embodiment, the material of the invention may be used as a packaging material. For this purpose, preferably, the material of the invention is in the form of a sheet, film o foil. Even more preferably, the material of the invention is in the form of a sealable sheet. In another preferred embodiment, 2 or more sheets in agreement with the invention are forming a bag.

In another one, it is applied over the product to be isolated by spraying.

From the environmental point of view, the material of the invention appears to be a highly marketable product as it promotes the protection of the environment by reducing the packages from petroleum-derived sources. Also, it uses a natural raw material that may promote the economical development of the north zone of Argentina where tapioca is grown.

On the other hand, another object of the invention is a biodegradable, biocompatible and non-toxic sheet, composed of a material comprising a matrix composed by starch, preferably of waxy type tapioca or corn starch and, even more preferably, of tapioca starch and starch nano-crystals dispersed in said matrix, being said starch nano-crystals, preferably, of waxy type corn starch. Particularly, sheets may be bonded onto another, or to other, sheets of the same material, by the application of water and pressure to the site of bonding. In another particular embodiment, sheets may be bonded onto another, or to other, sheets of the same material by the application of a temperature higher than about 90° C.

Up to date, no sheets, foils, films or biodegradable coatings with nanometric reinforcement are disclosed in the literature, of the waxy type corn starch, designed to be used as packaging. Also, the literature does not disclose the application of tapioca starch based coatings, reinforced with corn starch nano-crystals.

The biodegradable sheets, foils, films o coatings of the invention are different from the ones prepared by Angellier et al (see Biomacromolecules 7 (2006) 531-539), in various aspects: The chosen concentration of 33% by weight of glycerol is related to works performed by Famá et al (see Carbohydrate Polymers 66 (2006) 8-15), as it is considered that said concentration appears to be perfect to obtain films that are resistant enough and not fragile in the moment of handling. In fact, while in the above mentioned 2006 publication of Angellier et al, it is disclosed that with a 30% by weight of glycerol they found elongations higher than 200% with fracture tensions not higher than 0.5 MPa, the inventors of this invention have been able to obtain elongations higher than 90% with fracture tensions higher than 3.5 MPa for an approximate glycerol percentage. Thus, it is thought that the foils, films and sheets of the invention have good mechanic properties with respect to the flexibility and resiliency with the used concentration of plasticizer. On the other hand, the films of Angellier et al are not prepared by using a ramp of temperatures for gelatinization or by using a degassing process such as the one used for the manufacturing of the foils of the invention. In fact, for the manufacturing of the films, foils or sheets of the invention, to steps or stages are used, after the gelatinization and before the addition of the solution of Waxy type corn starch nano-crystals. This last degassing stage is imperative to avoid small bubbles that cannot be seen at a glance and which will considerably affect the values obtained in the dynamic mechanic analyses. On the other hand, for the procurement of sheets, foils or films of the invention, the addition of aqueous solution of nanocrystals is performed once the solution has been sonicated, this proceeding not being disclosed in the publication by Angellier.

The sheets of the invention are also different from the ones disclosed by Angellier in that it his publication there is not disclosed a concentration of nano-crystals as low as the one used in the present invention (2.5% by weight). Even though these authors evaluated mechanic properties at low concentrations of 5%, the properties of permeability to water vapor were not evaluated. In particular, there are various works in the literature that study the behavior of compounds of Waxy starch and starch nanoparticles, however there is no history of the use of this type of nanoparticles in tapioca starch or, as far as we know, there are not antecedents of the influence of the addition of the nanoparticles on the permeation properties of the matrix material (either Waxy corn or tapioca starch).

Finally, from the above mentioned Angellier publication, it is not shown that the herein disclosed films may be used as coatings, bags or containers.

In accordance to a particular embodiment, the biodegradable, biocompatible and non-toxic sheet of the invention has a permeability to water vapor of less than or equal to about 2.7×10⁻¹: g·m·^{—1}·s⁻¹·Pa⁻¹ and/or hast between about 100 micrometers and about 350 micrometers of thickness. Sheets of the invention may resist elongations higher than 90% with breaking tensions higher than 3.5 Mpa.

The sheets of the invention may be odorless, colorless and transparent and, in particular, may be edible and also, suitable to be consumed by celiac patients. Likewise, the sheets of the invention may be manufactured to obtain the required flexibility for a determined application.

On the other hand, biodegradable, biocompatible and non-toxic sheets of the invention may be degraded when put in contact with a solution with a pH of less than about 2. In particular embodiments, sheets in agreement with the invention may be dissolved when they are contacted with a solution of pH of less than about 1.

As required by any particular embodiment, sheets in agreement with the invention may also include one or more substances selected from the antimicrobial agents, colorants, flavoring agents, sweeteners and perfumes.

On the other hand, another object of the invention is, the use of two or more sheets in agreement with the invention, to elaborate a bag, in particular an “envelope” bag type. Since they are formed by starch, sheets of the invention are hydrophilic, thus allowing the adhesion sites to be bonded to each other by applying certain humidity and pressure.

On the other hand, the invention includes the use of a biodegradable, biocompatible and non-toxic sheet, comprising a material formed by a matrix composed by starch and starch nano-crystals dispersed in said matrix, to package foodstuff. In particular, it involves the use of sheets of the invention to protect a food from oxidation and/or decomposition. In another embodiment, it involves the use of sheets in the conservation of aroma of foodstuff.

It is also an object of the invention, a procedure to protect a food from degradation or to keep the smell of food, comprising immersing a foodstuff in a solution comprising the biodegradable, biocompatible and non-toxic material of the invention.

It is also another object of the invention, a procedure to protect a food from degradation or to keep the smell of food, comprising spraying or pulverizing the food with a solution comprising the biodegradable, biocompatible and non-toxic material of the invention.

The coatings of the invention are highlighted by their feature of preservants of freshness, naturality and useful quality of the food to be applied on, avoiding the deterioration by oxidation or microbial attack thereto. Likewise, the development of the gel and of the films and their application to foodstuff was designed in order to be easily accessed.

Due to the materials used, and their manufacturing process, the coating is more economic than any other coating currently used in the market (such as e.g., the polyethylene or PVC films).

It preserves freshness, naturality and useful quality of the food, by preventing its deterioration by oxidation or microbial attack for a longer period. Also, it is more resistant to breakage than the conventional coatings.

The inventors of this invention have found that by means of the use of the material and sheets of the invention, biodegradable little bags may be prepared to package coffee, cereals and fruits. Thus, it is possible to avoid the prompt oxidation suffered by the fruits once they are separated from their peel or cut. Likewise, through the invention it is possible to avoid or retard the loss of humidity and aroma suffered by cereals and coffee over time.

The bags prepared with the material or sheets of the invention are practical for food, they are light and may be totally edible as the case may require. Likewise, they can be prepared to completely disappear with permanent contact with water.

The material of the invention may meet all the required features so that the film is considered edible, and also:
It retards the migration of humidity: reduces the transfer of humidity between the product and the surrounding environment.
It retards the transport of gases (O₂, CO₂): Many foodstuffs are rapidly deteriorated due to the oxidation of lipids, vitamins and components of their pigments. The edible material of the invention may be used to prevent the transfer of in some products such as nuts, thus extending the life and notably reducing the cost of external packaging materials. Also, it would allow for a coating suppressing the aerobic breathing of fresh fruits and vegetables, in a way analogous to the storage at controlled atmosphere, by reducing the cost of equipment and operation of controlled atmosphere storage chambers.
It retards the migration of oils and fats: The material of the invention is highly impermeable to fats and oils. Thus, it could be used as a coating for foodstuff destined to be fried in oil, retarding the absorption of oil to the interior of the. This way, the product would keep its nutritional and organoleptic quality.
It retards the transport of solutes: The biodegradable foils of the invention may retard the transfer of solutes, thus keeping a high concentration of same on the surface of the foodstuff. Also, they may be used in order to minimize the diffusion of salts inside de foodstuff.
It improves the mechanic properties in case of handling and imparts additional structural integrity to the foodstuff: The edible film of the invention could reinforce the structure of the food, thus improving its durability due to manufacturing, storage and distribution. For example, they could be applied to frozen foodstuffs, avoiding their breakage due to handling; or to fresh products, by reducing the damage to the epidermal cells and thus avoiding them to turn brown.
It supports feeding additives: The edible foils of the invention may serve as a transport of antimicrobial agents, antioxidants and other preservatives, and control the localization and extended release of them on the foodstuff, without excessively avoiding the general concentration of additives on the foodstuff. For example, the foils of the invention may contain potassium sorbate in order to minimize the microbial contamination.

On the other hand, the material of the invention may be used as a vehicle in the transport of drugs since this, in the presence of gastric acids, is dissolved by allowing the drug escape with time. Thus, the material of the invention may be used in the controlled release of drugs, for example, in tablets, capsules and granulates.

On the other hand, the small sized bags obtained from the material of the invention are perfectly used to package and contain cosmetic products in a dry status, such as, for example, powders, talc and granulates. Having into account that the cosmetic companies are continuously worried about the number and type of packages used in their products, the material of the invention is introduced as a good option to substitute the unrenewable packages.

Also, the bags or packages manufactured with the material of the invention may be used as a vehicle in the dosing of powder detergents. This would allow to dose the product in the exact amount, without the same being in contact with user, since the dosing package is directly introduced in the washing system and in a progressive manner dissolved along with the detergent upon the contact with water.

Likewise, since the material may be used either in the form of gel or in thermoplastic foils, it would be able to substitute the commercial PVC films or be used to manufacture small bags. In particular, in the case of the gel, this may be obtained through the same proceeding as described above before the molding. This gel may be used by directly immersing a foodstuff, for example a cut fruit, therein and allowing to dry for about 60 minutes, thus achieving a coating which will isolate the food and reduce the process of oxidation and loss of tastes and aromas. The gel may also be sprayed or pulverized, by the use of a compressed air spraying gun.

### EXAMPLES

Methodology

Starch Matrix

The tapioca starch (Bernesa S.A., Buenos Aires, Argentina) has a composition of 72 w/w. % of amylopectin and 28 w/w. % of amylose. The waxy type corn starch (Roquette S.A., Lestrem, France) contains 99 w/w. % of amylopectin. The plasticizer used was glycerol (Baker, purity 99.9 w/w. %).

Waxy Corn Starch Nano-Crystals

Nanocrystals were obtained by acid hydrolysis of 36.725 g of the Waxy corn starch in 250 ml of sulphuric acid (HB_{2B}SOB_{4B}) 3.16 M at 40° C. and constant stirring (100 rpm) for 5 days. Subsequently, the crystals were washed and separated in distilled water con successive distillations until neutral pH. Then they were stored at 4° C. with some drops of chloroform. The morphological characteristics of the nanoparticles were studied by scan and transmission electronic microscopy.

Procurement of Films

The thermoplastic starch matrix and compounds were obtained by molding, by mixing tapioca starch or corn with glycerol (plasticizer) and distilled water. 15 g of starch and water were blended (2:1 by weight) and this mixture was dispersed in 185 g of distilled water. The mixture was heated to jellification temperature ˜70° C. and the gel was degassed for 30 min with vacuum with a mechanic pump. In the case of compounds, at this stage the suspension of nano-crystals is added in the desired amount (from 2.5-5 w/w. % relative to the total mass of starch, plasticizer and nanocrystals). After that, the mixture is stirred again for min at 250 rpm and degassing was finished for one additional hour. Finally, the mixture was poured into Petri dishes and was cured in an oven at 50° C. for 24 hours, thus obtaining films between 100-350 μm of thickness.

The obtained films may vary in thickness according to the amount of material which is added in the moment of molding. This thickness may vary in agreement with the desired application, being it generally, for most of uses, of a thickness between about 200 and about 350 μm.

Coatings

In the case of the gel coating, the material is ready after the degassing and before the molding. The product to be coated is directly immersed with the gel or also it is sprayed with a spraying gun and it is allowed to dry at room temperature for 60 minutes. The operation may be repeated as needed.

In the case of the film, it is obtained after de oven curing. The foils are easily detached from the molds and are ready to be used. They may be used to coat trays with foodstuffs or to directly coat a fruit or any other foodstuff.

For the manufacturing of bags or containers, two foils are used and with a film sealing device with temperatures of about 100° C. the borders bonded by both foils are sealed, without the material being broken or degraded.

The thus prepared bags may support a vacuum pressure of 0.015 mmHg with a vacuum mechanic pump, which is interesting when the product is meant to be isolated in the absence of air or through a mixture of gases.

### Example 1

The material of the invention, in the form of a sheet or film, was made as follows:

15 g of starch and water were blended (2:1 by weight) and this mixture was dispersed in 185 g of distilled water. The mixture was heated with a slope of 1.59° C./min for 28 minutes to jellification temperature ˜70° C. and the obtained gel was degassed for 30 min with vacuum with a mechanic pump. At this stage the suspension of nano-crystals is added, previously sonicated in the desired amount (2.5 to 5 w/w % relative to the total mass of starch, plasticizer and nanocrystals). After that, the mixture was stirred again for 10 min at 250 rpm and degassing was finished for one additional hour. Finally, the mixture is poured into Petri dishes, (in the case of sheets, films or foils) and is cured in an oven at 50° C. for 24 hours, to obtain sheets of between 150-300 μm of thickness.

### Example 2

On the sheets of the invention the following assays were performed:
Morphology of starch nanoparticles by Transmission Micrography TEM and Scan Electronic Microscopy FE-SEM. From these results arise aggregates of between 1-5 μm between Nanocrystals of approximately 50 nm of size.
Characterization of sheets by Infrared Spectroscopy and X Ray Scattering, showing that the presence of nanocrystals is caracterizable even at low concentrations (about 2.5%).
Characterization of sheets by Scan Electronic Microscopy FE-SEM, showing that the glycerol plasticizer is homogeneously distributed and interacting with nanocrystals.
Dynamic Mechanic Analysis, revealing that there is an increase in the storage module of 380%, passing from values for the non-reinforced films from 3.80×10⁷ Pa to 1.47 Pa×10⁸ for the films with 2.5% of nanocrystals.
Water Vapor Permeability Tests: Its permeability to water vapor is 2.7×10⁻¹⁰ g·m·⁻¹·s⁻¹·Pa⁻¹. Thus, said permeability is lower than the one for other biodegradable sheets such as, for example, the sheet composed of plasticized wheat gluten (7×10⁻¹⁰ or the one for amylose (3.8×g·m·⁻¹·s⁻¹·Pa⁻¹). The permeability to water vapor was calculated in agreement with the ASTM E96-00 Rule. For that, the films were conditioned for two weeks in desiccators at 25 C and 43% relative humidity (this equilibrium is reached with a saturated solution of K₂CO₃) before being submitted to test. This material has a water vapor permeability lower than other biodegradable films such as the film consisting of with plasticized wheat gluten (7×10⁻¹⁰ g·m·⁻¹·s⁻¹·Pa⁻¹ or of amylose (3.8×10^{-10 g·m·}⁻¹·s⁻¹·Pa⁻¹). This effect may be associated to the phenomenon of winding path which to be followed by the spread vapor. The presence of nanocrystals creates a hard path for the spread of water molecules through the film, in spite of the low load concentration. This high efficiency is attributed to its nanometric size and good dispersion in the matrix.

### Example 3

With the sheets of the invention bags or containers may be manufactured, which are made by the union of two of them, then directly heat-sealing them with heat or water. A procedure to be used in the procurement of the same is as followed:

Sheets obtained in the same way as described in example 1 are heat-sealed. The heat sealing may be performed by means of a bag sealing device, by sealing the borders of the union of two sheets. Borders may be between 20 and 5 cm in width and/or length, and may be square or rectangular. A sealing temperature of about 90° C. was used for a period of one to two minutes.

If desired, a vacuum atmosphere, gas or a mixture of gases may be applied to the thus obtained bags. The thus prepared bags supported a vacuum pressure of 0.015 mm Hg with a mechanic vacuum pump.

### Example 4

With the bags prepared in agreement with what was described in the previous example, different types of foodstuffs were wrapped:
Apple, kiwi and strawberry pieces. The oxidation of the same becomes noticeable after 48 hours of storage at room temperature (25° C.)
The pieces of bananas showed apparent oxidations after 4 days of wrapping at room temperature (25° C.).
Various cereals. These kept their crunchy state and freshness after 48 hours of storage at room temperature (25° C.) and at a relative humidity higher than 50%.
Commercial soluble coffee: the product retained its characteristic smell and its humidity after 72 hours of storage at room temperature of 25° C. and at a relative humidity higher than 50%. Likewise the smell of coffee is retained for more than one week without the product losing its original feature.

### Example 5

With the bags prepared in agreement with what is described in example 4, different cosmetic and cleaning products were wrapped:
Powder laundry detergents: The bag is slowly degraded in water thus allowing for the dosage of the product in a sustained form.
Makeup Powders: The product is not affected by room relative humidity. Room humidity does not affect its color or apparent texture.

### Example 6

The material of the invention may be used as dosing device of cosmetically or therapeutically active substances. In laboratory tests, the sheets obtained in agreement with el example 1, they were dissolved, and/or degraded in smaller parts, after about 28 minutes of being added to solutions with pH of less than 1. On the other hand, the sheets prepared in agreement with example 1, are softened and lose material after 48 hs of being added to solutions with a pH higher than 2. The results of these trials show that the sheets of the invention, in the presence of gastric acids, will be dissolved allowing one—or various—therapeutically active substances be escaped, in a controlled manner.

### Example 7

The material obtained in agreement with Example 1, may be used as a coating directly after the stage of gelatinization and before the molding in the Petri dishes. The gel obtained from this material may be sprayed or pulverized by aspiration, which is produced with a compressed air spraying gun. The elements to be coated may be immersed in this gel directly if pulverization is not allowed. The procedure is as follows:

After the degassing stage of the gel and the addition of nanocrystals, the preparation is placed in a pulverizing gun in order to spray the elements to be coated at approximately 15 cm of distance. After allowing drying for approximately one hour, if needed, the solution may be sprayed again. Optionally, the formulation of Example 1 to be pulverized may be modified by the addition of a food additive such as, for example, potassium sorbate (0.1 a 0.2 gr).

In laboratory assays, different fruits, vegetables and cheeses were sprayed. At room temperature, the sprayed products and exposed to at room temperature did not show apparent oxidation after 24 hours of being sprayed. The fruits that resisted more than 24 hours were the kiwi and the strawberries, in some cases resisting more than 48 hours. The soft cheeses and the ones of the Camembert type did not experience decomposition for periods of up to about 48 hours.

In particular, the addition of sorbate increased the resistance to oxidation of fruits and cheeses in about 24 hours.

The material of the invention pulverized on the foodstuff is odorless, colorless and transparent.

Likewise, being based on starch is edible and may be dethatched rapidly from the applied surface by means of a simple washing with tap water.

### Example 8

The material obtained in agreement with Example 1 may be used directly to coat foodstuffs and other products, when it is not desired to use the bags prepared from example 2.

The sheet obtained in agreement with example 1 is detached from the Petri and is ready to be used to coat any foodstuff, either by wrapping the same or by placing the film on trays or containers for products to be wrapped.

The thickness of the sheets may be effectively controlled by the use of the molding or casting technique. This way, sheets of a thickness between about 100 and about 350 μm were obtained, without the same losing their properties.

Foils of different sizes or forms were obtained, as the material of the invention is adapted to the mold where the sheet is cast and dried.

The films of the invention were submitted to quasi-static tensile tests such as the ones described by Fama et al (Famá L., Rojas A, Gerschenson L, Goyanes S. LWT 38 (2005) 631-639). The results showed that these films support elongations higher than 90%, with breaking tensions higher than 3.5 MPa.

### Example 9

The materials obtained in agreement with the proceeding disclosed in Example 1 were obtained, but using tapioca starch or waxy type corn starch as starting material but using tapioca starch and corn starch nano-crystals as a matrix material.

For the films formed by a matrix of Waxy starch, in comparison with the films based on tapioca starch, higher increments were obtained in the values of storage module, with respect to the compounds with the matrix without reinforcement. The storage module at 50° C. is from 7.34×106 Pa for the matrix, to 4.2×107 Pa for the compound, corresponding to an increase of 471%.

As a disadvantage, with the films prepared with Waxy starch as the matrix, water permeability values lower than the one obtained with the films prepared with tapioca starch were obtained. The obtained values are shown in the following table:

| Films | WVP * 10⁻¹⁰ (g/seg · m · Pa) 0/58% RH |
|---|---|
| Formed with Matrix with | 2.7 ± 0.7 |
| tapioca starch | |
| Formed with waxy type corn | 6.8 ± 0.1 |
| starch | |

1. A biodegradable, biocompatible and non-toxic material, characterized in that it is used to isolate and/or to protect a product from the environment, wherein said material comprises a matrix composed by starch, glycerol and starch nano-crystals dispersed in said matrix.

2. A biodegradable, biocompatible and non-toxic material, as defined claim 1, characterized in that it is used to isolate and/or to protect a product from the environment, wherein said material comprises a matrix composed by tapioca starch, glycerol and starch nano-crystals dispersed in said matrix.

3. A biodegradable, biocompatible and non-toxic material, as defined in claim 1, characterized in that it is used to isolate and/or to protect a product from the environment, wherein said material comprises a matrix composed by waxy starch, glycerol and starch nano-crystals dispersed in said matrix.

4. A biodegradable, biocompatible and non-toxic material, as defined by claim 1, characterized in that the starch nano-crystals dispersed in said matrix are corn starch nano-crystals.

5. A biodegradable, biocompatible and non-toxic material, as defined by claim 4, characterized in that said starch nano-crystals of corn have an average size of less than about 100 nm.

6. A biodegradable, biocompatible and non-toxic material, as defined by claim 5, characterized in that said starch nano-crystals of corn have an average size between about 50 nm and about 100 nm.

7. A biodegradable, biocompatible and non-toxic material, as defined by claim 2, characterized in that said nanocrystals are in a ratio between about 2.5 and about 5% by weight regarding the total weight of the material.

8. A biodegradable, biocompatible and non-toxic material, as defined by claim 1, characterized in that the product to be isolated is a food.

9. A biodegradable, biocompatible and non-toxic material, as defined by claim 1, characterized in that the product to be isolated is a pharmaceutical product.

10. A biodegradable, biocompatible and non-toxic material, as defined by claim 1, characterized in that the product to be isolated is a cosmetic product.

11. A biodegradable, biocompatible and non-toxic material, as defined by claim 1, characterized in that the product to be isolated is a cleaning product.

12. A biodegradable, biocompatible and non-toxic material, as defined by claim 1, characterized in that the product to be isolated is in the form of powder, granulate or small pieces.

13. A biodegradable, biocompatible and non-toxic material, as defined by claim 1, characterized in that it is used as a packaging material.

14. A biodegradable, biocompatible and non-toxic material, as defined by claim 1, characterized in that it is applied over the product to be isolated by spraying.

15. A biodegradable, biocompatible and non-toxic material, as defined by claim 1, characterized in that is in the form of a sheet.

16. A biodegradable, biocompatible and non-toxic sheet, as defined by claim 15, characterized in that it is a sealable sheet.

17. A biodegradable, biocompatible and non-toxic sheet, as defined by claim 16, characterized in that it may be bonded to another sheet of the same material by the application of water and pressure to the site of bonding.

18. A biodegradable, biocompatible and non-toxic sheet, as defined by claim 16, characterized in that it can be bonded to another sheet of the same material by the application of a temperature higher than about 90° C.

19. A biodegradable, biocompatible and non-toxic sheet, as defined by claim 16, characterized in that it has a water vapor permeability of less than or equal to about 2.7×10⁻¹⁰ g·m·⁻¹·s⁻¹·Pa⁻¹.

20. A biodegradable, biocompatible and non-toxic sheet, as defined by claim 16, characterized in that has between about 100 and about 350 micrometers of thickness.

21. A biodegradable, biocompatible and non-toxic sheet, as defined by claim 16, characterized in that it is odorless, colorless and transparent.

22. A biodegradable, biocompatible and non-toxic sheet, as defined by claim 16, characterized in that it is an edible sheet.

23. A biodegradable, biocompatible and non-toxic sheet, as defined by claim 16, characterized in that it resists elongations higher than 90% with breaking tensions higher than 3.5 Mpa.

24. A biodegradable, biocompatible and non-toxic sheet, as defined by claim 16, characterized in that it degrades when contacted with a solution of pH of less than about 2.

25. A biodegradable, biocompatible and non-toxic sheet, as defined by claim 16, characterized in that it dissolves when contacted with a solution of pH of less than about 1.

26. A biodegradable, biocompatible and non-toxic sheet, as defined by claim 16, characterized in that it also comprises one or more substances selected from the antimicrobial agents, colorants, flavoring agents, sweeteners and perfumes.

27. A biodegradable, biocompatible and non-toxic sheet, as defined by claim 26, characterized in that it comprises a sorbate.

28. A biodegradable, biocompatible and non-toxic sheet, as defined by claim 27, characterized in that it comprises potassium sorbate.

29. A biodegradable, biocompatible and non-toxic sheet, as defined by claim 28, characterized in that it comprises between about 0.1 g and about 0.2 g of potassium sorbate per 100 g of material.

30. The use of a biodegradable, biocompatible and non-toxic sheet, as defined by claim 16, characterized in that it is used to elaborate a bag.

31. The use of a biodegradable, biocompatible and non-toxic sheet, as defined by claim 16, characterized in that it is used to elaborate a bag of the “envelope” type.

32. The use of a biodegradable, biocompatible and non-toxic sheet, as defined by claim 16, characterized in that it is used to package foodstuff.

33. The use of a biodegradable, biocompatible and non-toxic sheet, as defined by claim 32, characterized in that it is used to protect foodstuffs from oxidation.

34. The use of a biodegradable, biocompatible and non-toxic sheet, as defined by claim 32, characterized in that it is used to protect foodstuffs from decomposition.

35. The use of a biodegradable, biocompatible and non-toxic sheet, as defined by claim 32, characterized in that it is used to preserve the aroma of foodstuffs.

36. A procedure to protect a food from degradation or to keep the smell of food, characterized in that it comprises immersing a foodstuff in a solution comprising the biodegradable, biocompatible and non-toxic material of claim 1.

37. A procedure to protect a food from degradation or to keep the smell of food, characterized in that it comprises spraying or pulverizing the food with a solution comprising the biodegradable, biocompatible and non-toxic material of claim 1.

38. A procedure for the procurement of a biodegradable, biocompatible and non-toxic material, as defined by claim 1, characterized in that it comprises obtaining a matrix by mixing starch with glycerol and water, heating by means of a slope of temperatures to gelificación, submitting no less than 2 stages of degasification and adding the previously sonicated starch nano-crystals.
